(19) United States
(12) Patent Application Publication
(10) Pub. No.: US 2019/0046822 A1
(43) Pub. Date: Feb. 14, 2019

(54) AUTOMATIC FIRE EXTINGUISHER

(71) Applicants: MITSUI CHEMICALS INDUSTRIAL PRODUCTS LTD., Bunkyo-ku, Tokyo (JP); NICHIBOU CO., LTD., Shinagawa-ku, Tokyo (JP)

(72) Inventors: Masaya IWASAKI, Otake-shi, Hiroshima (JP); Yuichi KOUGA, Shinagawa-ku, Tokyo (JP)

(21) Appl. No.: 16/078,933

(22) PCT Filed: Jul. 11, 2017
(86) PCT No.: PCT/JP2017/025291

§ 371 Date: Aug. 22, 2018

(30) Foreign Application Priority Data
Jul. 12, 2016 (JP) 2016-137565

(51) Int. Cl. A62C 35/10; A62C 35/02

(52) U.S. Cl. CPC A62C 35/10; A62C 35/023

(57) ABSTRACT

An automatic fire extinguisher that is installed onto a lithium battery for automobiles, that is capable of extinguishing a fire in the event of overheating or inflammation of the battery and can even be used in confined locations. The automatic fire extinguisher comprises a bag, in which a film (1) made of a polyethylene, spread over the top and under the bottom of an 8 mm-thick rectangular frame (2) made of a polyethylene resin and projecting parts (4) arranged at regular intervals within the frame (2), cover the frame (2) and the projecting parts (4) to form the bag, with the films having many recesses (8) that rupture upon contact with flame in the event of a fire formed thereon at regular intervals. A fire extinguishing liquid with high electric insulation and nitrogen gas of 1.2 MPa are sealed in the bag.

### TECHNICAL FIELD

The present invention relates to an automatic fire extinguisher having a fire extinguishing agent enclosed and sealed in a bag formed by a film made of a synthetic resin, wherein the bag ruptures upon contact with flame in the event of a fire, thereby releasing the extinguishing agent and extinguishing the fire.

### BACKGROUND ART

As an automatic fire extinguisher of this type, an apparatus is known which includes a pressure vessel containing a fire extinguishing agent and a pressurizing agent, along with a tube made of a synthetic resin that is connected to the pressure vessel by which the extinguishing agent and the pressurizing agent are supplied from the pressure vessel, wherein the fire extinguishing agent is sprayed at the fire extinguishment target when the tube comes into contact with flame and is perforated, thereby extinguishing the fire.

### PRIOR ART DOCUMENTS

### Patent Documents

Patent Document 1: Japanese Registered Utility Model No. 3170412

### SUMMARY OF THE INVENTION

### Problem to be Solved by the Invention

The above-mentioned automatic fire extinguisher is beneficial in that because it uses no sensors or control devices that require a power source supply such as batteries, it causes no sparks due to electricity when detecting a fire or activating at the time of extinguishing a fire, preventing the possibility of a combustible gas or fine particles igniting and exploding even when installed in locations with a significant amount of combustible gas or fine particles, in addition to being able to be safely installed in explosion-proof areas; moreover, even if a tube becomes dirty due to long term installation, there is no possibility of loss of the fire extinguishing function thereof, with fire extinguishment capable of being performed without problems regardless of any loss in power source due to power outages and the like, and because there is no need for batteries, no replacement of batteries or maintenance is necessary. However, because the apparatus includes a pressure device and is bulky, it cannot be used as a fire extinguisher for batteries exemplified by lithium ion batteries in confined locations, such as for example automobiles, in which installation space is limited.

The object of the present invention is to provide a sheet-like automatic fire extinguisher capable of being installed even in confined locations by enclosing and sealing a fire extinguishing agent in a bag made up of a synthetic resin sheet.

### Means for Solving the Problem

The automatic fire extinguisher according to the present invention includes a bag. The bag is formed of a frame, a plurality of projecting parts or partition walls arranged within the frame and having the same height as the frame, and a film made of a synthetic resin spread over the top and under the bottom of the frame and the projecting parts or partition walls. The top and bottom films are connected to the projecting parts or partition walls in the vertical direction at regular intervals, while the overlapping portions of the film protruding outward from the frame are welded or bonded for sealing. The space surrounding the projecting parts or the spaces divided by the partition walls within the bag are filled with a fire extinguishing agent. With at least some or a majority of the partition walls having an opening, the spaces divided by the partition walls are in communication with other adjacent spaces. As the fire extinguishing agent, a material that is liquid at normal temperature and vaporizes upon heating is preferably used.

In a preferred embodiment of the invention, the space surrounding the projecting parts is filled with a pressurizing agent together with the fire extinguishing agent; alternatively, the spaces divided by the partition walls that join both films are filled with a pressurizing agent together with the fire extinguishing agent.

### Advantageous Effects of the Invention

The automatic fire extinguisher according to the present invention is configured such that, in the event of a fire, the film forming the bag ruptures due to flame, thereby releasing a fire extinguishing agent and enabling fire extinguishment. Because there is no need for sensors or control devices which require a power supply such as batteries, the automatic fire extinguisher has a simple configuration, does not require maintenance, and will not ignite even when installed in explosion-proof areas as it causes no sparks even at the time of fire extinguishment, making it safe. In addition, the fire extinguishing function thereof does not suffer even if becoming dirty due to long term installation and regardless of any loss in power source due to power outages and the like. Moreover, the automatic fire extinguisher according to the present invention does not require much installation space because the bag is thin, containing only a pressurizing agent and a fire extinguishing agent even when a pressurizing agent is added in the bag. Furthermore, because the bag can be formed into such sizes as will fit into limited installation spaces, even in confined locations such as the lithium ion batteries of automobiles where there is very little installation space, it can be inserted between batteries or cells, attached or laminated onto batteries or cells, or installed on the ceiling of the battery storage space, making installation easy.

### BRIEF DESCRIPTION OF THE DRAWINGS

FIG. 1 is a plan view of an automatic fire extinguisher according to the present invention.

FIG. 2 is a cross-section taken along the A-A line in FIG. 1.

FIG. 3 is an enlarged cross-section of the principal part of the automatic fire extinguisher illustrated in FIG. 1.

FIG. 4 is a plan view of an automatic fire extinguisher according to another embodiment.

FIG. 5 is a plan view of an automatic fire extinguisher according to yet another embodiment.

FIG. 6 is a plan view of an automatic fire extinguisher according to a different embodiment.

FIG. 7 is a schematic view of an aspect of an experiment conducted using the automatic fire extinguisher illustrated in FIG. 6.

### DETAILED DESCRIPTION OF THE INVENTION

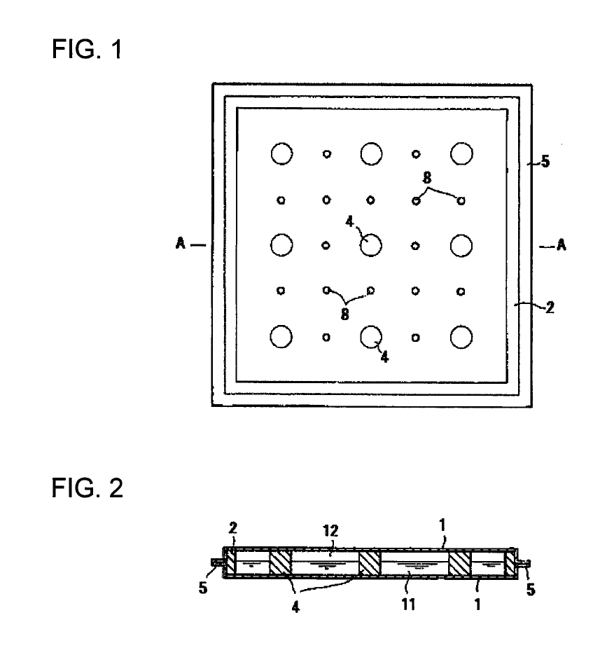

The automatic fire extinguisher illustrated in FIGS. 1 and 2 comprises a bag made up of film made of a synthetic resin and a fire extinguishing agent sealed within the bag, which will be described in detail below. The bag is formed of film 1 made of a synthetic resin, frame 2, and projecting parts 4. Among these, film 1 has a thickness of approximately 0.5-3 mm, with the material thereof preferably being a polyolefin with a melting point of 110-160° C. such as a polyethylene, crosslinked polyethylene, or polypropylene.

Frame 2 and projecting parts 4 are both preferably made of a polyethylene. In the example illustrated in FIG. 1, frame 2 is a square and projecting parts 4 have a circular cross-section. For example, both frame 2 and projecting parts 4 have a height of 8 mm. Projecting parts 4 are longitudinally and laterally arranged at regular intervals within the frame, film 1 made of the polyethylene is spread over the top of and under the bottom of frame 2 and projecting parts 4, while overlapping portions 5 of the film protruding outward from frame 2 are heat sealed or bonded to form a square bag.

In FIG. 1, frame 2 making up the bag may be in any shape apart from a square, such as a rectangle, circle, or ellipse depending on the installation location of the fire extinguisher. Projecting parts 4 may also be in any shape apart from the circular cross-section illustrated in FIG. 1, for example, a rectangular shape such as a square or rectangle.

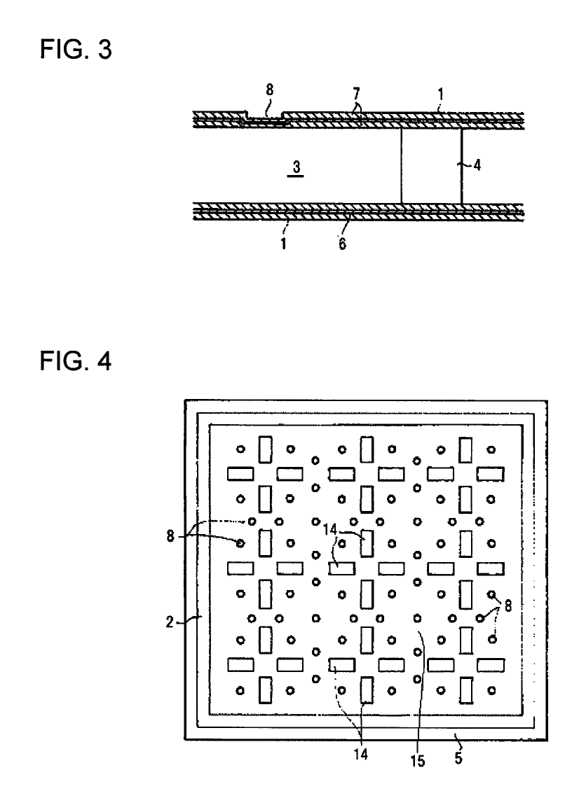

On film 1 spread over the top and under the bottom of the frame, small-diameter circular recesses 8 serving as rupture portions are formed in locations other than the locations at which projecting parts 4 are arranged, at intervals of for example preferably 50 cm or less, more preferably 3 cm or less, with a diameter of, for example, approximately 0.5-1 cm. These recesses 8 have a depth that is approximately half the thickness of film 1 (see FIG. 3). Apart from recesses, the rupture portions may also be, for example, cross-shaped slits that do not penetrate the film.

As the fire extinguishing agent, a gas with electric insulation, for example, a halide fire extinguishing chemical is preferably used. More preferably, a material that is liquid at normal temperature and vaporizes upon heating in the event of a fire, for example, liquid fire extinguishing agent 11 with electric insulation manufactured by 3M, NOVEC 1230 (FK-5-1-12), which is dodecafluoro-2-methylpentane-3-on, is used.

As described above, although the extinguishing agent is enclosed in a bag, a pressurizing agent is preferably filled into the bag together with the fire extinguishing agent. This is because a pressurizing agent filled under a pressurized state makes it easier for the extinguishing agent to gush forth. As the pressurizing agent to be used, a pressurized inactive gas, for example, nitrogen gas, may be used. The fire extinguishing agent and the inactive gas are enclosed in the bag at the time of forming the bag and, after filling space 3 surrounding projecting parts 4, sealed by heat sealing or bonding the film at the rim of the bag.

The automatic fire extinguisher according to the present embodiment is used, for example, as a fire extinguisher for automobile batteries exemplified by lithium ion batteries, with the use of a polyolefin resin having a melting point of 110-160° C. for film 1 enabling fire extinguishment that can cope with the overheating or inflammation of lithium ion batteries.

For the case in which a fire extinguishing liquid is used as a fire extinguishing agent or a pressurized inactive gas is used as a pressurizing agent together with a fire extinguishing agent, it is also desirable to impart gas barrier properties to film 1 to prevent the fire extinguishing liquid from vaporizing and decreasing or to reduce the decrease in gas pressure due to the inactive gas. To impart such gas barrier properties to film 1, one can laminate medium-density polyethylene resin 7 to sandwich ethylene-vinyl alcohol copolymer (EVOH) resin layer 6 therebetween as illustrated in FIG. 3, or deposit aluminum on film 1 of the above-mentioned material.

Recesses 8 formed on film 1 in a preferred embodiment preferentially rupture to other thicker portions when coming into contact with flame in the event of a fire, because film 1 is thinner at the bottom of the recesses. If the size of recesses 8 is made smaller to make the ruptured holes smaller, especially in a pressurized state due to the pressurizing agent, the gushing force of the fire extinguishing agent increases, making fire extinguishment relatively more reliable than the case in which a large rupture occurs, which makes the gushing force of the fire extinguishing agent weaker.

While the above-mentioned recesses 8 are circular in shape, they may be rectangular or any other shape. At any rate, recesses 8 are so shaped, sized, and shaped such that they easily rupture due to a fire and, for the case in which an inactive gas is used as the pressurizing agent, such that they do not rupture under the gas pressure of the sealed nitrogen gas.

Furthermore, if too thick, film 1 becomes bulky, adding to the manufacturing costs; in contrast, if too thin, it becomes difficult to form recesses 8 and film 1 becomes incapable of withstanding the internal pressure for the case in which it is pressurized by an inactive gas. For this reason, the film desirably has a thickness of approximately 0.5-3 mm.

As the fire extinguishing agent, a fire extinguishing liquid with high electric insulation is desirably used. This is because even if film 1 of the bag is ruptured due to malfunction, thereby causing the fire extinguishing liquid to gush forth and come into contact with electric circuits, batteries, or personal computers as fire extinguishment targets, it will not or at least rarely result in breakdown.

For the case in which a pressurizing agent (inactive gas) is added, if the pressurizing force from the pressurizing agent is great, although the gushing force of the extinguishing agent when extinguishing a fire increases, the bag swells due to the swelling of film 1, likely making the fire extinguishing equipment bulky; in contrast, if the pressurizing force is small, although no swelling of film 1 occurs, the gushing force of the fire extinguishing agent decreases. For this reason, the pressurizing force is desirably approximately 0.05-2.0 MPa.

FIG. 4 illustrates another exemplary fire extinguisher, in which, instead of projecting parts 4 arranged within frame 2 in the fire extinguishing equipment illustrated in FIG. 1, partition walls 14 are vertically and horizontally arranged to form cross shapes, the vertical and horizontal partition walls 14 are spaced apart by regular gaps at intersections, and rectangular spaces 15 divided by the partition walls 14 on four sides are preferably filled with a pressurized inactive gas apart from the fire extinguishing liquid similarly to the bag according to the above described embodiment. It should be noted that each space 15 is in communication with longitudinally and laterally adjacent spaces 15 because partition walls 14 are spaced apart at the middle portions and because of the gaps at the intersections.

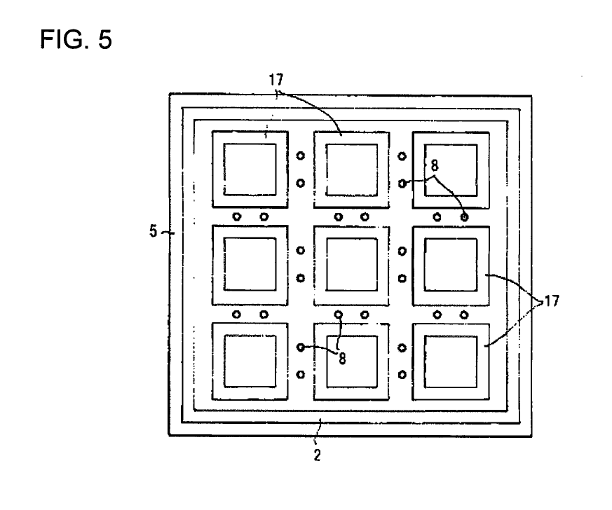

FIG. 5 illustrates yet another fire extinguisher, in which the top and bottom films are connected by square pipe-like projecting parts 17 instead of projecting parts 4 having a circular cross-section of the fire extinguisher as illustrated in FIG. 1. A fire extinguishing liquid and an inactive gas are not filled into projecting parts 17, but rather filled into the space surrounding projecting parts 17. Although on film 1 according to each embodiment illustrated in the drawings, all recesses 8 are formed in locations at which neither projecting parts 4, 17 nor partition walls 14 are arranged, it poses no particular problem if they are formed at locations where protrusions 4, 17 or partition walls 14 are arranged.

While the automatic fire extinguisher according to each of the above-mentioned embodiments forms a quadrangle in planar view, circular, elliptical, rhombic, and other polygonal-shaped fire extinguishers may be used depending on the available space of the location at which the fire extinguisher is to be installed.

Furthermore, the automatic fire extinguisher according to each of the above-mentioned embodiments is configured such that the bag is formed of rectangular frame 2, projecting parts 4, 17 or partition walls 14 arranged within the frame, and film 1 spread over the top and bottom surfaces of frame 2, space 3 illustrated in FIG. 3 surrounding projecting parts 4, the spaces encompassed by partition walls 14, or the space surrounding the projecting parts 17 are formed within frame 2, and the bag is sealed with each space preferably being filled with an inactive gas together with a fire extinguishing liquid.

Regarding the above-mentioned films 1 illustrated in FIG. 3, while medium-density polyethylene layers 7 are on both sides of EVOH resin layer 6, a film having aluminum deposited on one side thereof may be used without forming EVOH resin layer 6.

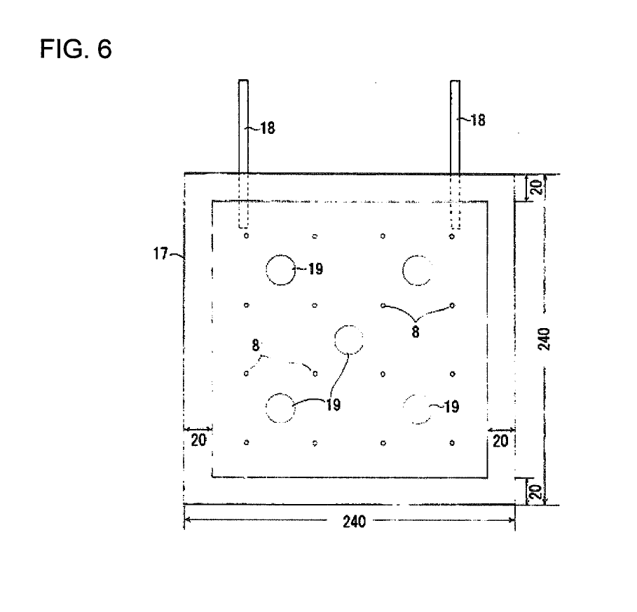

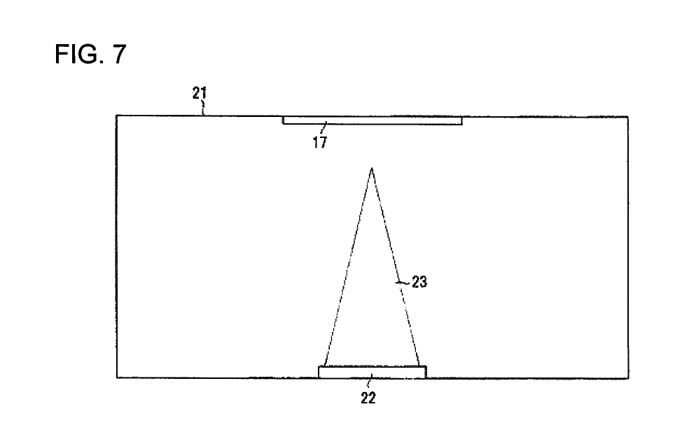

The automatic fire extinguishing equipment illustrated in FIG. 6 is configured such that the rims of a pair of square films 1 made of a polyethylene, on which recesses 8 are longitudinally and laterally formed at regular intervals, are heat sealed, a pair of tubes made of a polyethylene, preferably tubes 20 made of a polyethylene having an EVOH layer, are inserted and fixed to both sides of a side (the upper side in FIG. 6), and bag 19 is heat sealed at several locations (five locations in FIG. 6) to form fused portions 21 for preventing swelling. Preferably, a pressurized inactive gas is injected together with a fire extinguishing liquid via tubes 20, and after injection, the tube ends are closed with steel caps placed thereon or joints having a check valve joined thereto.

### EXPERIMENTAL EXAMPLE 1

Bag 19 illustrated in FIG. 6 having no recesses 8 on film 1 was used. The bag was injected with 60 cc of the above-mentioned fire extinguishing liquid NOVEC 1230 manufactured by 3M and nitrogen gas pressurized to approximately 0.05-0.1 MPa to bring it into a stretched state in which the thickness of the space was 2 mm, the film thickness was 1 mm, and the total thickness was 4 mm. A fire extinguisher comprised of bag 19 of the size illustrated in FIG. 6 was used and fixed onto the ceiling of box 23 made of polycarbonate having dimensions of 40×80×40 cm. Then, when a container having dimensions 16×16×2 cm into which water and benzene had been stored was ignited, the fire was extinguished in 23 seconds. In the figure, 25 schematically illustrates the flame before it was extinguished.

### EXPERIMENTAL EXAMPLE 2

A fire extinguishment experiment was conducted in the same manner as in Experimental Example 1 using bag 19 of Experimental Example 1, except that the injection of nitrogen gas was omitted to leave the bag in an unpressurized state. The fire was extinguished in 28 seconds after ignition.

### EXPERIMENTAL EXAMPLE 3

A fire extinguishment experiment was conducted in the same manner as in Experimental Example 1 using a similar bag 19 of Experimental Example 2, except that the bag did not have the fused portions 21 for preventing swelling. The fire was extinguished in 32 seconds after ignition.

### INDUSTRIAL APPLICABILITY

While the automatic fire extinguisher according to the present invention is suitably used for batteries exemplified by lithium ion batteries used in automobiles (electric vehicles, hybrid vehicles, plug-in hybrid vehicles) and the like, apart from these, it can be used by being attached to electric products, for example, personal computers, computer circuits, and the like.

### REFERENCE SIGNS LIST

1. Film
2. Quadrangular frame
3. Space
4, 17. Protrusion
5. Seal portion
6. EVOH resin layer
7. Medium-density polyethylene layer
8. Rupture portions (recesses)
11. Extinguishing agent
14. Partition
15. Space
19. Bag
20. Tube
21. Fused portion

1. An automatic fire extinguisher, comprising:
frame;
a plurality of projecting parts or partition walls arranged within the frame and having the same height as the frame;
a bag formed of a film made of a synthetic resin spread over the top and under the bottom of the frame and the projecting parts or partition walls, the top and bottom films being connected to the projecting parts or partition walls in the vertical direction at regular intervals, while the overlapping portions of the top and bottom films protruding outward from the frame are welded or bonded for sealing; and
a fire extinguishing agent filled into the space surrounding the projecting parts or spaces divided by the partition walls in the bag,
wherein at least some or a majority of the partition walls have an opening such that the spaces divided by the partition walls are in communication with other adjacent spaces via the opening.

2. The automatic fire extinguisher according to claim 1, wherein the fire extinguishing agent is liquid at normal temperature and vaporizes upon heating.

3. The automatic fire extinguisher according to claim 1, wherein the film of at least one surface of the top and bottom surfaces of the bag has a rupture portion with low strength that is easily rupturable by flame.

4. The automatic fire extinguisher according to claim 1, wherein the space surrounding the projecting parts or the spaces divided by the partition walls are filled with a pressurizing agent together with the fire extinguishing agent.

5. The automatic fire extinguisher according to claim 1, wherein the films have aluminum deposited thereon or an ethylene-vinyl alcohol copolymer (EVOH) resin laminated thereon.

6. The automatic fire extinguisher according to claim 1, wherein the rupture portion is a recess in a circular, rectangular, or any other shape having a small cross-sectional area or a non-penetrating slit, and is formed at intervals of 50 cm or less.

7. The automatic fire extinguisher according to claim 1, wherein the film made of the synthetic resin is made of a polyolefin resin with a melting point of 110-160° C., such as a polyethylene, crosslinked polyethylene, or polypropylene.

8. The automatic fire extinguisher according to claim 4, wherein pressurization by the pressurizing agent is performed within the range of 0.05-2.0 MPa.

9. The automatic fire extinguisher according to claim 1, wherein the film has a thickness of 0.5-3 mm.

10. The automatic fire extinguisher according to claim 1, wherein the fire extinguishing agent is a fire extinguishing liquid with high electric insulation.

11. The automatic fire extinguisher according to claim 1, wherein the frame and the projecting parts are both made of a polyethylene.
